(19) United States
(12) Patent Application Publication
(10) Pub. No.: US 2004/0202148 A1
(43) Pub. Date: Oct. 14, 2004

(54) System and method of data stream transmission over MPLS

(76) Inventor: Thomas Kuehnel, Princeton, NJ (US)

Correspondence Address: SUGHRUE, MION, ZINN, MACPEAK & SEAS, PLLC, 2100 Pennsylvania Avenue, N.W.,, Washington, DC, 20037-3213, US

(21) Appl. No.: 09/772,946

(22) Filed: Jan. 31, 2001

(51) Int. Cl. H04L 12/66; H04L 12/28; H04L 12/56; H04J 3/22

(52) U.S. Cl. 370/352; 370/401; 370/466; 370/395.1

(57) ABSTRACT

In a system and method for efficient transport of streaming data over MPLS, incoming data is multiplexed to generate a single data stream. A composite data stream is then generated by selectively combining certain packets of the single data stream with an IP header or generating new packets with a full IP header at a predetermined timing interval, and transmitted to a first MPLS converter that assigns a MPLS label to data packets in the composite data stream, in accordance with information from said IP header. The composite data stream is then transported and routed to a second MPLS converter, via a MPLS network, that strips the MPLS labels from the data packets. A discriminator separates the stripped, combined data stream into non-IP header data output via a demultiplexer to generate multiple outgoing data streams, and IP header data output to a traffic monitor that controls said routing mechanism.

### BACKGROUND OF THE INVENTION

1. Field of the Invention

The present invention relates to a system and method of efficient transmission of streamed data (e.g., voice) in a packet data network. More specifically, the present invention relates to a method for transmission of streamed data using a multi-protocol label switching (MPLS) network to transport stream data having a reduced protocol overhead. Furthermore, the method can also be used for circuit emulation of traditional transmission lines (e.g., E1, T1) over an MPLS network.

2. Background of the Prior Art

A prior art circuit-switched network that is widely deployed in today's local access and long distance network is designed for voice telephony. Multiple virtual circuits, each carrying a single voice connection at 64 kbit/s, are multiplexed for efficient transport over a single line or channel using multiplexing techniques like PDH (plesiochronous digital hierarchy) and SDH (synchronous digital hierarchy). The network topology, i.e. the logical and physical interconnection of network elements is typically a static one. Changes in the traffic pattern that require changes of the topology or capacity on links or rerouting traffic in case of equipment failure or line outages require human intervention.

However, the prior art switched circuit network has various problems and disadvantages. For example, the architecture is inflexible, a significant transport overhead occurs due to the lack of statistical multiplexing, and the resources for each circuit must be reserved in advance by using complex connection control procedures.

For at least the above reasons, the prior art voice telephony network is not suited for the transport of packet data (e.g., Internet traffic). Thus, operators must maintain and operate two independent networks, one for telephony voice traffic and the other one for packet data transport, which adds to the operational costs of running two independent networks.

With the advent of the Internet, which is purely based on packet data, the need to use a common transport technology for voice telephony and packet data became more apparent. As a solution, ATM (Asynchronous Transfer Mode) emerged as a technology suited to transport packet data as well as traditional circuit switched data. ATM facilitates statistical multiplexing by interleaving small chunks of payload belonging to different connections. Those chunks of payload are transferred in small fixed size cells, called ATM cells. A unique identifier that is part of the cell header distinguishes cells that belong to different virtual connections on a given link. ATM is a connection-oriented multiplexing technology suitable for time sensitive (e.g., voice) and non-time sensitive (e.g., most packet data) traffic.

As a consequence, ATM is widely deployed in today's networks that support voice and data transport alike. However, the connection control mechanisms to setup and release connections were derived from the telephony system, and have a disadvantage in that they do not scale for the kind of data traffic generated by the Internet. New connection control technologies like the prior art MPLS (Multi-protocol Label Switching) were introduced to facilitate transport of Internet packet data over an ATM network. MPLS combines the Internet protocol (IP) with a connection-oriented transport bearer (e.g., ATM). Internet protocol data units (IP-PDUs) travel along predetermined paths, which are statically set up between an ingress and egress point of the MPLS network. A label is assigned to the packet based on address information contained in the packet header. The label identifies the path throughout the network. Such a label-switched path (LSP) provides the conduit for all IP-PDUs regardless of the logical connection traversing the network between a given pair of nodes (i.e., ingress node and egress node). A special treatment in terms of Quality of Service (QoS) can be applied to LSPs.

The Internet and its protocol suite were initially designed for the transmission of data that are not time sensitive (e.g., email, telnet, file transfer etc.). However, with the advance of Internet technology and the introduction of mechanisms to provide QoS guarantees, the Internet is increasingly used as a bearer of time-sensitive data (e.g., voice).

Since any IP-packet is routed independently based on the contained address information, no prior connection setup is needed. The tradeoff is the higher overhead due to the global address information that is part of the protocol overhead. While the transmission efficiency is increased for as the payload becomes larger, there is a trade-off between packet length and packetization delay. Thus, the number of streaming data units (e.g. voice samples) to be transferred in one packet is limited, and depends on the specific delay requirements of the application.

If packetized streaming data is transported over an MPLS network in a traditional way, a certain amount of streaming data is buffered, packetized and encapsulated as an IP-packet. Upon entering the MPLS network, a label that references the path through the MPLS network corresponds to the IP-address information and is added. The mapping between destination or a group of destinations and the label can be done statically or dynamically using a control protocol like the prior art Label Distribution Protocol (LDP). A destination or a group of destinations are identified by their respective IP-addresses.

As a consequence for the transmission efficiency, the combined overhead of label and IP-header is added to the payload. Especially if packets are short, this overhead may be significant. The following example illustrates the protocol overhead incurred for voice transmission with 40 8-bit samples contained in one packet: If the Internet protocol header comprises 28 bytes (IP and UDP), 8 bytes are required for AAL5 (ATM Adaptation Layer 5) encapsulation. The ATM Cell header that contains the label information accounts for additional 5 bytes. If for instance the number of voice samples concatenated for one packet is increased, the efficiency improves but the delay increases as well which has a negative impact on the perceived quality.

### SUMMARY OF THE INVENTION

An object of the present invention is to provide an efficient, robust and implementable mechanism to transport packetized streaming data efficiently over an MPLS network.

Yet another object of the present invention is to reduce the transport overhead required, and permit routing within the network and without requiring an IP header on each data packet.

Another object of the present invention is to provide QoS for streaming data transport over an MPLS network by exploiting underlying transport bearer capabilities. If ATM is used as an underlying bearer, different ATM adaptation layers can be used for different traffic types, like AAL1 or/and AAL2.

The present invention includes a system for streaming data transport over a multi-protocol label switching (MPLS) network, comprising an ingress router that comprises a first multiplexer that receives and processes at least one input data stream and outputs single stream data comprising a plurality of data packets, each of said plurality of data packets having a data portion, an IP traffic generator that generates IP routing packets at a fixed or dynamic predetermined interval in response to a trigger signal, a second multiplexer, coupled to said first multiplexer and said IP traffic generator, that inserts said IP routing packets into said single stream data, and a first MPLS converter, coupled between said second multiplexer and said MPLS network, that attaches a label to each of said plurality of data packets to generate a combined data stream comprising a plurality of data packets of a first type interspersed between a plurality of data packets of a second type, each of said data packets carrying address information generated in accordance with each of said IP routing packets, wherein one-to-one mapping is performed between said label and said address information of the said IP-routing packets. The system further comprises an egress router, comprising, a second MPLS converter, coupled to said MPLS network, that receives said combined data stream from said MPLS network and removes said label from each of said plurality of data packets of said combined data stream, a discriminator, coupled to said second MPLS converter, that separates said combined data stream into IP routing packets and said single stream data, a de-multiplexer, coupled to said discriminator, that receives said single stream data and generates at least one output data stream, wherein said de-multiplexer reconstructs said at least one input data stream, and a traffic monitor, coupled to said discriminator, that receives said IP routing packets for IP stream data and generates said trigger signal, to provide for monitoring and feedback functions, wherein said system is configured to transport streamed data bidirectionally.

Additionally, a system for streaming data is provided, comprising a first router that receives input stream traffic and generates a combined data stream comprising a plurality of data packets that include a first type of data packet and a second type of data packet, generated in accordance with routing information, an MPLS network that is coupled to said first router and receives and transports said combined data stream in accordance with said routing information, and a second router coupled to said MPLS network and generating output stream traffic, wherein said first router is capable of operating as said second router and said second router is capable of operating as said first router to transport streamed data bidirectionally.

Further, a method of transport of packetized streaming data over a multi-protocol label switching (MPLS) network is also provided, comprising the steps of generating a composite data stream by selectively combining a plurality of data packets of a single stream of packetized data, said single stream comprising a plurality of incoming data streams, with a data stream containing full IP header information at a predetermined interval, and in accordance with a routing address identifying a destination of said composite data stream, and transmitting said composite data stream to a first MPLS converter that assigns a MPLS label to each of said plurality of data packets in said composite data stream, in accordance with the IP header information that includes routing information of a second MPLS converter. The method further comprises the steps of transporting said composite data stream to said second MPLS converter that is configured to strip said MPLS label from each of said plurality of data packets of said composite data stream, separating said stripped, combined data stream into non-IP header data and IP header data having said IP native format, and outputting said non-IP header data to generate outgoing data and outputting said IP header data to control said routing mechanism via a feedback signal, wherein said MPLS network is configured to transport streamed data bidirectionally.

Also provided is a method of streaming data transport over a multi-protocol label switching (MPLS) network, comprising the steps of generating a composite data stream comprising a first data packet adjacent to a plurality of second data packets in accordance with a native format of an incoming data stream, transporting said composite data stream over said MPLS network, and producing output stream traffic, wherein said MPLS network is configured to transport streamed data bidirectionally.

### BRIEF DESCRIPTION OF THE DRAWINGS

The accompanying drawings, which are included to provide a further understanding of preferred embodiments of the present invention and are incorporated in and constitute a part of this specification, illustrate embodiments of the invention and together with the description serve to explain the principles of the drawings.

FIG. 1 illustrates a MPLS traffic streamed data structure according to a preferred embodiment of the present invention;

FIG. 2 illustrates a MPLS network model according to the preferred embodiment of the present invention;

FIG. 3 illustrates a block diagram of the preferred embodiment of the present invention; and

FIGS. 4A and 4B illustrate a method for efficient transmission of streamed data according to the preferred embodiment of the present invention.

### DETAILED DESCRIPTION OF THE PRESENT INVENTION

Reference will now be made in detail to the preferred embodiment of the present invention, examples of which are illustrated in the accompanying drawings. In the present invention, the terms are meant to have the definition provided in the specification, and are otherwise not limited by the specification.

The preferred embodiment of the present invention includes edge network elements (i.e., an ingress router and an egress router) capable of transporting streamed data in an MPLS network. The ingress router receives at least one input data stream and inserts a full IP-packet between selected packets of the input data stream to form a combined data stream. Based on the IP-destination address that is part of the full IP packet a label is added to each of the packets of the combined data stream. The label identifies the path the labeled packet takes throughout the MPLS network. A label-switched path is used for MPLS network transport and to output the combined data stream to the egress router, which removes label and outputs the streamed data in its native format. The system operates bidirectionally.

The time intervals may be fixed or dynamically calculated. Since all of the MPLS data packets do not contain the IP header information, the overhead is minimized.

The egress network element reconstructs the native format of the streaming data. The preferred embodiment of the present invention allows network elements that are part of the MPLS transit network to treat the data as if had been all IP-traffic. Further, the streamed data transport can be bi-directional, as the system is set up symmetrically. Accordingly, the ingress router is collocated with an egress router that processes the reverse direction of the data transport. The ingress and egress router can be physically combined in one or multiple network elements.

The present invention minimizes overhead for the transport of packetized streaming data over an MPLS network, and thus provides the means of converging the traditional circuit switched network and packet data network into a single transport network based on MPLS. Depending on the bearer network (e.g., ATM), specific features of the underlying bearer network can be exploited to provide QoS guarantees for certain traffic types. For example, different ATM adaptation layers (AAL) are defined to support different traffic types (e.g., AAL1 is used for circuit emulation, AAL2 for compressed voice traffic and AAL5 for data). In the prior art MPLS is defined for AAL5 encapsulation.

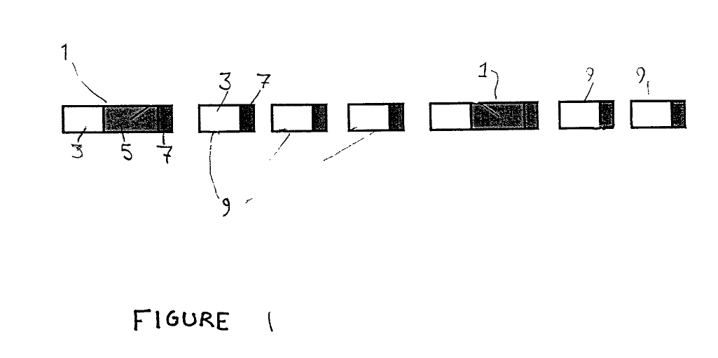

FIG. 1 illustrates the data structure of the MPLS transport system according to the preferred embodiment of the present invention. The data structure of the stream in the MPLS network includes MPLS protocol data units (PDUs) carrying a full IP packet 1, that may optionally contain a data portion 3, an IP header 5 selectively added to incoming data, and a label 7 added at the ingress router. The full IP packets 1 are interspersed at a predetermined interval between MPLS PDUs 9 that include a data portion 3 and the label 7 but do not include the IP header 5. All of the data packets will be labeled, such that the MPLS network processes the non-IP data as IP data due to the presence of the labels 7. Thus, the MPLS network is effectively “tricked” into transporting the non-IP data as if it were IP data.

The MPLS data packets 9 may carry part of the incoming multiplex control information as well as control overhead to facilitate the reconstruction of the initial data format following the transport conversion, i.e. multiplexing, packetization, de-packetization, and de-multiplexing. The first MPLS PDU containing a full-IP packet 1 establishes the path for the MPLS network using the known prior art procedures for the establishment of label switched path, such that overhead is not needed for the remainder of the data travelling on the path, and the destination (e.g., egress router) is configured to reconstruct the format of the data.

An IP traffic generator adds a valid IP header to select data packets or inserts the IP packet header 5 into the stream of data packets at a predetermined interval, which may range from a few 10's of milliseconds to multiple seconds. Then, the label 7 is added to all packets, IP and non-IP packets, to form the MPLS-PDUs 1 and 9, respectively. The value of the label on each link between MPLS network elements corresponds to the MPLS network path and is derived from the address information that is carried in the IP header. The mapping of IP-address information to a valid label is known by the prior art.

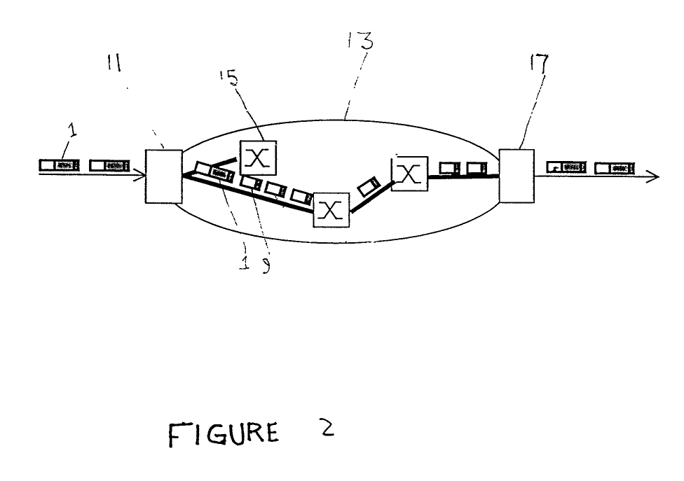

As illustrated in FIG. 2, the MPLS network 13 is coupled between the ingress router 11 and the egress router 17 that respectively map non-IP traffic into MPLS and vice versa, and insert or filter IP data packets. The ingress router 11 generates a single stream of MPLS PDUs that includes the full IP packet 1 spaced in between the plurality of non-IP data packets 9 at the predetermined time interval. The combined data stream may be routed by various elements such as MPLS switches or routers 15 commonly coupled within the MPLS network 13, in accordance with the label information carried by each MPLS PDU.

The egress router 17 receives the MPLS PDUs and outputs a plurality of data streams. Additional control information stored in the payload can be used at the egress router 17 to reconstruct the data format of the multiple data streams at the output. The egress router 17 may also communicate with the ingress router 11 to establish the predetermined rate of insertion of the IP headers 5 required to generate and insert the full IP packet 1 into the data stream transferred over the MPLS network.

As noted above, ingress router 11 and the egress router 17 of the system illustrated in FIG. 2 may be set up symmetrically to accommodate bidirectional operation of the system. For example, for reverse flow of streamed data the egress router 17 can be paired with an ingress router and receive incoming streamed data and generate the combined data stream, and the ingress router 11 can be paired with an egress router and receive the transported packets to output the plurality of data streams. Paired Ingress and egress router can be physically combined into one or multiple network elements.

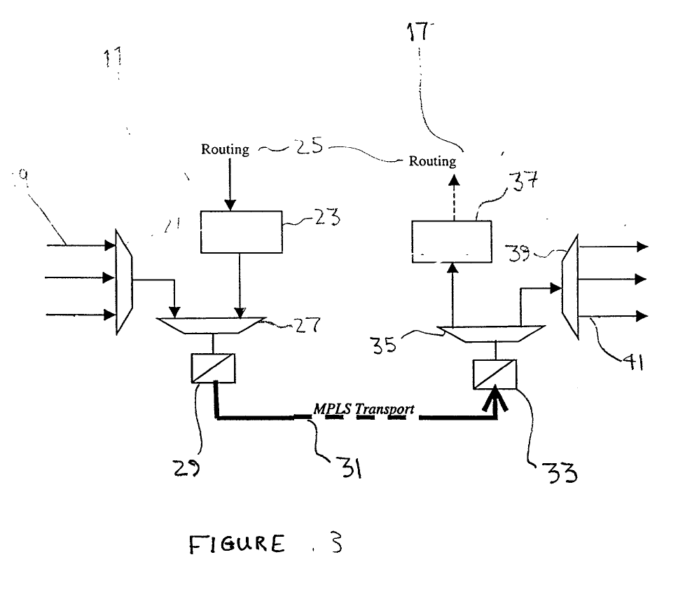

FIG. 3 illustrates a block diagram of the preferred embodiment of the present invention that uses switching, following the establishment of the label switched path throughout the MPLS network, to transport the data. The multiple incoming data streams 19 are received at the ingress router 11 that includes a first multiplexer 21. Multiplexing control information is implicitly embedded in the single data stream or explicitly stored in form of identifiers, and is used to reconstruct multiple outgoing data streams 41 at the egress router 17.

A routing mechanism 25 is coupled to an IP traffic generator 23 that inserts full IP packets or adds an IP header 5 to select data packets at the predetermined interval at a second multiplexer 27. The IP header 5 contains information including the IP source address (i.e. the address of the ingress router 11) and the IP destination address (i.e. the address of the egress router 17). The second multiplexer 27 receives and multiplexes inputs from the first multiplexer 21 and the full IP packet 5 from the IP traffic generator 23 at the predetermined intervals to output a combined data stream that is received by the first MPLS converter 29, which is coupled to the output of the second multiplexer 27 and adds the label 7 to the MPLS PDUs 9 and MPLS PDUs carrying a full IP data packets 1 in the combined data stream. The first MPLS converter 29 assigns the label 7 to the multiplexed stream based on the IP-destination address that is part of the full IP-packet header 5.

In the MPLS network 31, which is coupled to the ingress router 11 at the output of the first MPLS converter 29 and the routing mechanism 25, the data is passed using the MPLS network elements 15, as illustrated in FIG. 2. The frequency of setting up, or the time required to establish a new label switched path, is determined by the granularity of the predetermined time interval. For example, a greater predetermined time interval requires a longer time period to re-establish a new label switched path.

During the path establishment phase throughout the MPLS network 31, MPLS PDUs 9 not associated with IP header information are on “dead” routes (i.e., erroneous) and are discarded, stored or specially marked and processed in a different manner, depending on the network type. To simplify the discarding process MPLS PDUs not carrying a valid IP packet 1 can be specially marked using bearer specific information or tags. For example, odd labels can indicate a valid IP packet whereas even labels mark a data packet without IP information. In case of ATM, the Payload Type information field (e.g. coding as OAM (operation, administration and management), cell or 111) could be used for this purpose. However, the use of the bearer specific information like the payload type within the MPLS network must be carefully evaluated, because some network elements may process bearer information like OAM cells in a different manner.

The network elements within the MPLS network discard MPLS PDUs not containing a valid IP packet in case a new label switched path is set up which may be the result of traffic re-routing. If network elements do not discard packets, then part of the streaming payload is interpreted as an IP-address. Validity tests (e.g., CRC (cyclic redundancy checksum), protocol type) performed on the MPLS PDUs not containing a valid IP packet will fail and MPLS PDUs are ultimately discarded. This testing scheme can be exploited to reserve part of the payload to assure a wrong CRC generation (e.g. the bytes 10 . . . 11, corresponding to the location of the CRC if the MPLS payload were a regular IP packet, are set to 0). Alternatively, an unsupported version or protocol type could be set in the corresponding positions of the IP-header. A wrong destination can be avoided by inserting a valid destination address (e.g., bytes 20 . . . 23, corresponding to the location of the IP destination address if the MPLS payload were a regular IP packet.) in the payload. However, the insertion of additional information may lead to a fragmentation of the payload, and reduce the actual payload size.

The labeled data stream is transported in the MPLS network 31 to the egress router 17, which is coupled to an output of the MPLS network 31 and the routing mechanism 25. The egress router 17 includes a second MPLS converter 33 that strips the label 7 from the each of the received MPLS PDUs 1, 9. A discriminator 35 coupled to an output of the second MPLS converter 33 receives the combined stream of data packets 1, 9 and uses validity checks (e.g., flags and/or checksums) to separate the inserted IP packets from the non-IP traffic.

The non-IP traffic 9 is transmitted to a de-multiplexer 39 that is coupled to receive an output of the discriminator 35 and generates the outgoing multiple data streams 41 in the native format of the incoming data streams, using multiplexing control information included in the payload for reconstruction of the multiple data streams 41. The IP data are passed to a traffic monitor 37 coupled to receive an output of the discriminator 35, and the IP header traffic generates routing information for the routing mechanism 25.

While FIG. 3 illustrates one-direction of operation of the preferred embodiment of the present invention, it is understood that in order for the system to operate symmetrically the ingress router 11 is combined with an egress router 17, and the egress router 17 is combined with the ingress router 11 for the reverse of stream of data. Thus, the system can operate in a bidirectional manner.

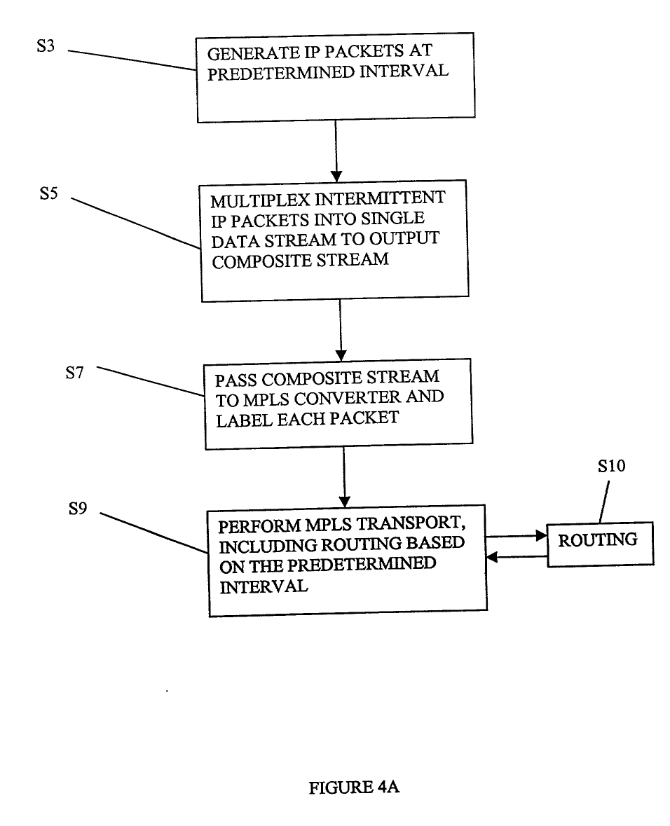

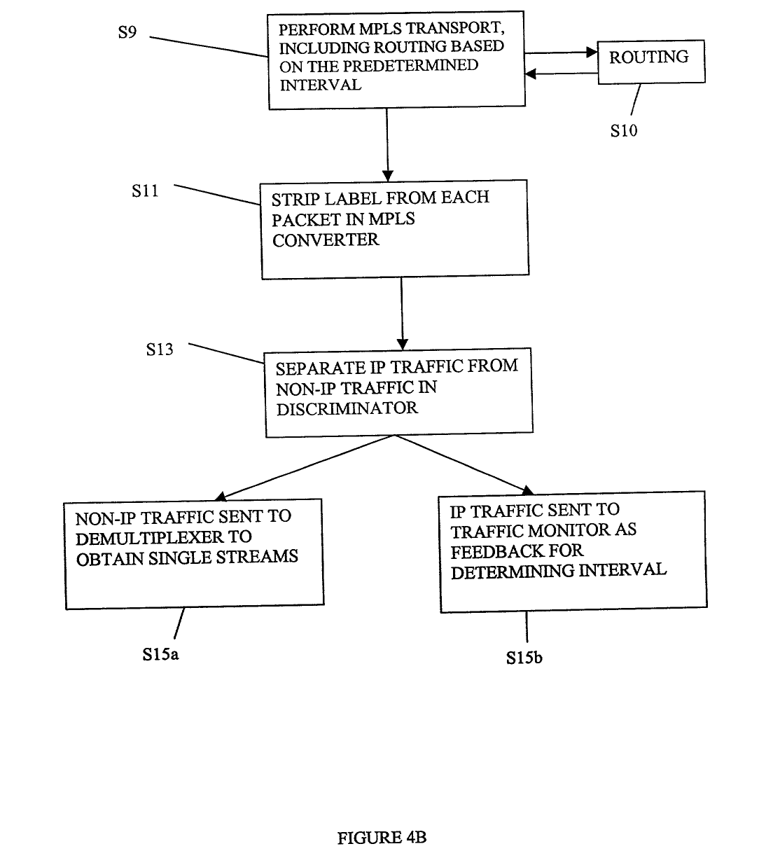

FIGS. 4A and 4B illustrate a method for efficient transport of streaming data according to the preferred embodiment of the present invention. In a step S3, full IP-packets 5 are generated by the IP traffic generator 23 in accordance with routing information from the routing mechanism 25, generated at a predetermined time interval. Here, the artificially generated IP packets are merged into the packet data stream to provide routing information, which is used to set up and maintaining the label switched path throughout the MPLS network.

Then, in a next step S5, the IP packets 5 are selectively inserted by multiplexing with the single data stream at the second multiplexer 27. In a further step S7, the above-described composite stream output from the second multiplexer 27 is passed to the first MPLS converter 29, and a label 7 is assigned to each incoming packet 1, 9. The incoming packets having a label 7 and an IP header 5 are full IP packets, and the intervening incoming packets not having IP headers are stream data packets 9. At this point, the data structure illustrated in FIG. 1 has been generated. A label 7 is attached to all data (including IP and non-IP). The IP routing packet 5 has a header that acts as a “dummy” header to essentially set up the label switched path throughout the MPLS network for the combined data stream. As noted above, the attachment of the label 7 enables the MPLS network to transport the non-IP data as if it were IP data on a previously established label switched path.

In the next step S9, MPLS transport is performed on the data stream, and may include additional steps. For example, a routing step S10 may be performed in accordance with the routing information from the routing mechanism 25, generated at a predetermined time interval, such that the full-IP data packet 1 is read by the routing element 15 to determine the IP address information. Further, data read by the routing element 15 not having IP header information is either removed or stored for later processing, depending on the specific network configuration.

As illustrated in FIG. 4B, in the next step S11, the MPLS PDUs from the MPLS transport network 31 are received in the egress router 17 at the second MPLS converter 33, which strips the label 7 from each MPLS PDU 1, 9. In a further step S13, the discriminator 35 separates the previously inserted IP traffic 5 from the data traffic portion 3 of the data packets 1, 9. In further steps S15a, S15b, respectively, the IP header 5 is sent to the traffic monitor 37 as a feedback information for setting the predetermined interval of the routing mechanism 25 that generates the routing information, and the non-IP traffic is sent to the de-multiplexer 39, which generates streams of output data 41 in the native format.

In the preferred embodiment of the present invention, the method can also operate bidirectionally. For example, the egress router 17 and the ingress router 11, as illustrated in FIGS. 2 and 3, are paired to convey data streams in both directions. Thus, the method of the preferred embodiment of the present invention permits transport of streamed data in a forward direction as illustrated in FIG. 3, as well as a reverse direction, with substantially identical steps for the reverse operation of the system.

The present invention has various advantages. Compared with the prior art methods, the present invention results in more efficient transmission, because each of the MPLS data packets does not have extra overhead associated with an IP header, which is only included at predetermined intervals. For example, the disadvantages of the prior art associated with having an IP header in each data packet are avoided by the routing scheme of the preferred embodiment of the present invention.

Additionally, the prior art problems associated with a frame and an IP header located in each data packet are resolved, as the IP header is only placed intermittently. A further advantage of the present invention is that little or no data is lost in case the path has to be re-routed and can be adjusted by the routing mechanism that controls the timing of the insertion of the IP header packets. Further, switching is used instead of routing. Thus, less additional computation is required for routing as compared with the prior art.

Another advantage of the present invention is that QoS for different transport bearers can be efficiently supported. In case of ATM, AAL1 and AAL2 offering timing synchronization features that can be used for transport of streaming data in an MPLS network that is effectively designed for AAL5 transport only.

It will be apparent to those skilled in the art that various modifications and variations can be made to the described preferred embodiments of the present invention without departing from the spirit or scope of the invention. Thus, it is intended that the present invention cover all modifications and variations of this invention consistent with the scope of the appended claims and their equivalents.

What is claimed is:

1. A system for streaming data transport over a multi-protocol label switching (MPLS) network, comprising:
an ingress router, comprising,
a first multiplexer that receives and processes at least one input data stream and outputs single stream data comprising a plurality of data packets, each of said plurality of data packets having a data portion,
an IP traffic generator that generates IP routing packets at a fixed or dynamic predetermined interval in response to a trigger signal,
a second multiplexer, coupled to said first multiplexer and said IP traffic generator, that inserts said IP routing packets into said single stream data, and
a first MPLS converter, coupled between said second multiplexer and said MPLS network, that attaches a label to each of said plurality of data packets to generate a combined data stream comprising a plurality of data packets of a first type interspersed between a plurality of data packets of a second type, each of said data packets carrying said label generated in accordance with each of said IP routing packets, wherein one-to-one mapping is performed between said label and said address information of each of the IP-routing packets; and
an egress router, comprising,
a second MPLS converter, coupled to said MPLS network, that receives said combined data stream from said MPLS network and removes said label from each of said plurality of data packets of said combined data stream,
a discriminator, coupled to said second MPLS converter, that separates said combined data stream into IP routing packets and said single stream data,
a de-multiplexer, coupled to said discriminator, that receives said single stream data and generates at least one output data stream, wherein said de-multiplexer reconstructs said at least one input data stream, and
a traffic monitor, coupled to said discriminator, that receives said IP routing packets for IP stream data and generates said trigger signal, to provide for monitoring and feedback functions, wherein said system is configured to transport streamed data bidirectionally.

2. A system for streaming data, comprising:
a first router that receives input stream traffic and generates a combined data stream comprising a plurality of data packets that include a first type of data packet and a second type of data packet, generated in accordance with routing information;
an MPLS network that is coupled to said first router and receives and transports said combined data stream in accordance with said routing information; and
a second router coupled to said MPLS network and generating output stream traffic, wherein said first router is capable of operating as said second router and said second router is capable of operating as said first router to transport streamed data bidirectionally.

3. The system of claim 2, wherein said second type of data packet comprises a label and a data portion, and said first type of data packet comprises a label, an IP header and a data portion, and wherein said data portion of each of said first type of data packet and said second type of data packet comprises at least one of a data payload, control information used to generate said output stream traffic, and an empty payload.

4. The system of claim 2, said MPLS network comprising:
a routing system that routes said combined data stream; and
at least one router element that is coupled to said MPLS network and one of discards, stores and marks said first type of data packet detected by said routing system for additional processing if an IP header is not detected in accordance with a validity test, and said routing system processes and routes said combined data stream in accordance with an IP header detected in said first type of data packet by said routing system wherein said system operates using a bearer selected in accordance with a traffic type.

5. The system of claim 2, said first router comprising:
a first multiplexer that receives said input stream traffic and outputs single stream data comprising a plurality of data packets, each of said data packets having a data portion;
an IP traffic generator that generates IP routing packets in response to a trigger signal generated at a fixed or dynamic predetermined interval;
a second multiplexer, coupled to said first multiplexer and said IP traffic generator, that receives said single stream data and said IP routing packets and inserts said IP routing packets into said single stream data in response to said routing information; and
a first MPLS converter that is coupled between said second multiplexer and said MPLS network, and attaches a label to each of said plurality of data packets, said label containing data generated in accordance with said IP header, and outputs said combined data stream to said MPLS network, wherein said label is attached to each of said plurality of data packets corresponding to the IP destination address contained in said IP header of the IP routing packets.

6. The system of claim 2, said second router comprising:
a second MPLS converter, coupled to said MPLS network, that receives said combined data stream from said MPLS network and removes a label from each of said plurality of data packets of said combined data stream;
a discriminator, coupled to said second MPLS converter, that separates said combined data stream into IP routing packets and said single stream data;
a de-multiplexer, coupled to said discriminator, that receives said single stream data and generates said output stream data, wherein said de-multiplexer operates in accordance with input stream traffic state information contained in said data portion of each packet to reconstruct said input stream traffic; and
a traffic monitor, coupled to said discriminator, that receives said IP header data and generates a trigger signal that provides monitoring and feedback for said system.

7. A method of transport of packetized streaming data over a multi-protocol label switching (MPLS) network, comprising the steps of:
generating a composite data stream by selectively combining a plurality of data packets of a single stream of packetized data, said single stream comprising a plurality of incoming data streams, with a data stream containing full IP header information at a predetermined interval, and in accordance with a routing address identifying a destination of said composite data stream;
transmitting said composite data stream to a first MPLS converter that assigns a MPLS label to each of said plurality of data packets in said composite data stream, in accordance with the IP header information that includes routing information to a second MPLS converter;
transporting said composite data stream to said second MPLS converter that is configured to strip said MPLS label from each of said plurality of data packets of said composite data stream;
separating said stripped, combined data stream into non-IP header data and IP header data having said IP native format; and
outputting said non-IP header data to generate outgoing data and outputting said IP header data to control said routing mechanism via a feedback signal, wherein said MPLS network is configured to transport streamed data bidirectionally.

8. The method of claim 7, comprising generating said IP header in response to a routing information generated by said routing mechanism, said generating step comprising:
inserting said IP header in selected data packets of said single data stream at a predetermined interval and adding said MPLS label to each of said selected data packets to generate a first type of data packet, and
generating a second type of data packet by inserting said MPLS label to each of a plurality of non-selected data packets of said single data stream, wherein said first type of data packet is interspersed between said second type of data packets at said predetermined interval.

9. A method of streaming data transport over a multi-protocol label switching (MPLS) network, comprising the steps of:
generating a composite data stream comprising a first data packet adjacent to a plurality of second data packets in accordance with a native format of an incoming data stream;
transporting said composite data stream over said MPLS network; and
producing output stream traffic, wherein said MPLS network is configured to transport streamed data bidirectionally.

10. The method of claim 9, said transporting step comprising transporting said composite data stream over said MPLS network in accordance with said first data packet or at a predetermined interval, by reading information from said first data packet in accordance with routing information, wherein said predetermined interval results in a router reading only said first data packet having IP header information.

11. The method of claim 9, wherein said first data packet is different from said plurality of second data packets when said native format is an IP format, and is inserted at a fixed or dynamic predetermined interval generated in accordance with a trigger signal generated in said producing step.

12. The method of claim 9, said producing step comprising the steps of:
stripping a label from said first data packet and said plurality of second data packets in said composite data stream;
separating said stripped, composite data stream into non-IP header data and IP header data; and
outputting said non-IP header data to generate said output stream traffic in said native format of said incoming data stream and outputting said IP header data to a traffic monitor that controls said routing of said MPLS network to generate a trigger signal that provides feedback and monitoring for said MPLS network.

13. The method of claim 9, wherein said first data packet is one of discarded, stored and marked by a router when said first data packet is not associated with IP header information, in accordance with a validity test.

14. The method of claim 9, said generating step comprising generating said composite data stream having at least one full-IP data packet comprising said first data packet positioned at a predetermined interval with respect to a plurality of labeled data packets comprising said plurality of second data packets.
